(19) United States
(12) Patent Application Publication
(10) Pub. No.: US 2002/0126357 A1
(43) Pub. Date: Sep. 12, 2002

(54) IBGP-based address resolution in GMPLS-based optical networks

(76) Inventor: Dmitry Ryumkin, Kanata (CA)

Correspondence Address: MARKS & CLERK, P.O. BOX 957, STATION B, OTTAWA, ON, K1P 5S7, CA

(21) Appl. No.: 10/087,745

(22) Filed: Mar. 5, 2002

Related U.S. Application Data
(60) Provisional application No. 60/273,320, filed on Mar. 6, 2001.

(51) Int. Cl. H04B 10/00

(52) U.S. Cl. 359/165; 359/154

(57) ABSTRACT

The present invention describes an automatically switched optical mesh network that provides the following advantages as compared to the known prior art. First, this solution eliminates the need for a centralized address database/directory, and second, this approach re-uses BGP, which may be implemented by the optical network for uses other than address resolution. The solution is accomplished by introducing an Internal Border Gateway Protocol (IGBP) based optical point of attachment distribution mechanism.

This invention claims the benefit of U.S. Provisional Application No. 60/273,320, filed Mar. 6, 2001.

### FIELD OF THE INVENTION

This invention relates to communications systems, and more particularly to automatically switched optical mesh networks with Optical UNI/GMPLS (User Network Interface/Generalized Multi-Protocol Label Switching) based control plane.

### BACKGROUND

The Optical Inter-working Forum (OIF) has been working on an Optical User Network Interface (UNI) Signaling specification (oif2000.125.3). This specification defines an Address Resolution service. With this service, a client device can: (1) request one or more client-layer addresses to be associated with an optical network point-of-attachment, and (2) supply a remote client-layer address and obtain the associated optical network point-of-attachment ID. The latter implies that an optical node is capable of obtaining the addressing information from other (remote) optical nodes. To do this it requires an exchange of certain information between the optical nodes. How this is accomplished is outside the scope of the UNI specification; rather it is left up to vendor-specific implementations.

The inventor herein is not aware of any existing solutions to the above-defined problem. One of the proposed solutions described in some IETF (Internet Engineering Task Force) and OIF drafts is to introduce a centralized database/directory. All optical nodes in the carrier's network would register their local optical network point-of-attachment and associated client-layer addresses with this directory, thereby making this information available to all other nodes (subject, of course, to policy restrictions). With such a solution, when an optical node receives the UNI Address Resolution Query for a particular remote client-layer address, it would query the directory to find the optical network point-of attachment corresponding to the client-layer address in question, and return it back to the client in the UNI Address Resolution Reply message. This solution incurs the burden of having to deploy and maintain a centralized database/directory, as well as other issues such as interoperability, different directory schemas, etc.

### SUMMARY OF THE INVENTION

This invention proposes a solution to this problem by introducing the IBGP (Internal Border Gateway Protocol) based optical network point of attachment distribution mechanism.

Instead of putting the address resolution and related information into an external database/directory, optical nodes exchange this information with each other by piggybacking IBGP messages sent over BGP (Border Gateway Protocol) connections configured between edge optical nodes. An IBGP message is triggered whenever an optical network point-of-attachment is assigned a client-layer address. Such an assignment may be done using: (1) a UNI Address Registration request; (2) a CLI (Command Line Interface) command; (3) an SNMP (Simple Network Management Protocol) request; or (4) other management protocols.

When a node receives an IBGP message, it stores the address resolution and related information. Thus each node involved in this IBGP exchange has complete knowledge of all optical network points-of-attachment and associated client-layer addresses existing in the network, and therefore, is capable of resolving the UNI Address Resolution Query request.

Therefore in accordance with a first aspect of the present invention there is provided a system for exchanging addressing information between optical nodes in an optical network comprising: address registration means to register an address assigned to an optical node; means to detect registration of an assigned address and to initiate a message to other nodes in the network in response thereto, said message carrying the address information; and means at each node to store the address information carried in the message.

In accordance with a second aspect of the invention there is provided a method of exchanging addressing information between optical nodes in an optical network comprising: registering an address assigned to an optical node; detecting registration of the assigned address and initiating a message to other nodes in the network in response thereto, the message carrying the address information; and storing, at each node, the address information carried in the message.

### BRIEF DESCRIPTION OF THE DRAWINGS

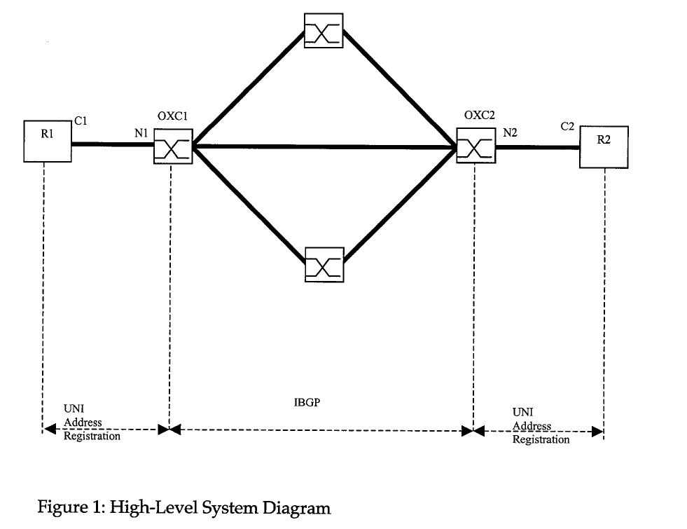

The invention will now be described in greater detail with reference to the attached drawing, wherein FIG. 1 is a high-level diagram of the system of the present invention.

### DETAILED DESCRIPTION OF THE INVENTION

For a better understanding of the invention as shown in FIG. 1, the following legend is provided:

R1 and R2 are client CPE (Customer Premises Equipment) boxes implementing UNI-C (User Network Interface-Client) functionality;

OXC1 and OXC2 (Optical Cross-Connect) are optical nodes implementing UNI-N (User Network Interface-Network) functionality;

C1 is a client-layer address for R1;

N1 is the optical network point-of-attachment corresponding to C1;

C2 is a client-layer address for R2;

N2 is the optical network point-of-attachment corresponding to C2.

Suppose R1 sends OXC1 a UNI Address Resolution Query message asking for the optical network point-of-attachment corresponding to C2—the client-layer address for R2. OXC1 replies with the UNI Address Resolution Response message containing N2—the requested optical network point-of-attachment. Note that N2 may be either a network-wide unique IP (Internet Protocol) address or a <OXC2's IP address, portid>tuple.

The remainder of this section provides a detailed walkthrough for this scenario.

Required Pre-Configuration:

1) OXC1 and OXC2 are configured as IBGP peers.

2) N2 is configured on OXC2. This may be done with CLI, SNMP, EMS (Element Management System) or some other means of management interface.

3) N1 is configured on OXC1. This may be done with CLI, SNMP, EMS or some other means of management interface.

Our Scenario:

4) R2 registers its client-layer address C2 with OXC2 by sending a UNI Address Registration request to OXC2. Alternatively, C2 may be associated with N2 by configuration (CLI, SNMP, EMS or other).

5) OXC2 sends the IBGP message toward OXC1 just as if it received the C2 address through an EBGP (External Boarder Gateway Protocol) session with R2. The IBGP message is extended to include N2.

6) OXC1 receives the IBGP message and memorizes the C2/N2 mapping. Note, because there is no EBGP session between OXC1 and R1, no EBGP message is triggered by the received IBGP message.

7) R1 sends the UNI Address Resolution Query message to OXC1 asking for the optical network point-of-attachment corresponding to C2.

8) OXC1 finds the previously stored C2/N2 mapping and sends the UNI Address Resolution Response message containing the requested N2 to R1.

The previous section described the implementation of the UNI Address Resolution Service. A similar service may be required even when UNI is not used at all. Suppose that connection setup requests are initiated by an NMS (Network Management System). From the network's perspective, the endpoints of the connection must be specified in terms of optical network points-of-attachment (N1 and N2 in our example). From the operator's perspective, however, it is preferable to think in terms of client-layer addresses (C1 and C2 in our example). So, a similar address resolution mechanism is required. This mechanism may be exactly the same as the one described above, with only one exception—proprietary NMS address resolution query/response is used instead of standard UNI Address Resolution Query/Response messages.

The present invention provides the following advantages as compared to the known prior art. First, this solution eliminates the need for a centralized address database/directory, whose shortcomings are described in the background section. Second, this approach re-uses BGP, which may be implemented by the optical network for uses other than address resolution. Peer and augmented IP/Optical inter-working models (see “IP over Optical Networks: A framework”, draft-many-ip-optical-framework-01) may be implemented by establishing EBGP sessions between optical and IP nodes, and IBGP sessions between optical nodes.

While specific embodiments of the invention have been described and illustrated it will be apparent to one skilled in the art that numerous changes can be implemented without departing from the basic concept. It is to be understood, however, that such changes will fall within the full scope of the invention as defined by the appended claims.

I claim:

1. A system for exchanging addressing information between optical nodes in an optical network comprising:
address registration means to register an address assigned to an optical node;
means to detect registration of an assigned address and to initiate a message to other nodes in the network in response thereto, said message carrying the address information; and
means at each node to store the address information carried in the message.

2. The system as defined in claim 1 wherein said address information represents a client-level address of a point of attachment of a node in the network.

3. The system as defined in claim 2 wherein the client-level address is the address of a unit of customer premise equipment (CPE) attached to the network.

4. The system as defined in claim 3 wherein said network has cross-connect switches for switching messages through the network.

5. The system as defined in claim 4 wherein said message is via an Internal Border Gateway Protocol (IBGP) over a Border Gate Protocol (BGP) connection.

6. The system as defined in claim 5 wherein the assignment registration is implemented by a User Network Interface (UNI) Address Registration request.

7. The system as defined in claim 5 wherein the assignment registration is implemented by a Command Line Interface (CLI) command.

8. The system as defined in claim 5 wherein the assignment registration is implemented by a Simple Network Management Protocol (SNMP) request.

9. The system as defined in claim 5 wherein the cross-connect switches are IGBP peers.

10. The system as defined in claim 9 wherein the optical node point of attachment is configured on the cross-connect switches using a CLI command.

11. The system as defined in claim 9 wherein the optical node point of attachment is configured on the cross-connect switches using a SNMP request.

12. The system as defined in claim 9 wherein the optical node point of attachment is configured on the cross-connect switches using an Element Management System (EMS).

13. The system as defined in claim 9 implementing a UNI Address Resolution service.

14. The system as defined in claim 9 implementing a Network Management System (NMS) address service.

15. A method of exchanging addressing information between optical nodes in an optical network comprising:
registering an address assigned to an optical node;
detecting registration of an assigned address and initiating a message to other nodes in the network in response thereto, said message carrying the address information; and
storing, at each node, the address information carried in the message.

16. The method as defined in claim 15 wherein the address information includes client-level address and network point of attachment information.

17. The method as defined in claim16 optical nodes exchange information by piggybacking Internal Border Gate Protocol (IBGP) messages sent over Border Gate Protocol (BGP) connections configured between edge optical nodes.

18. The method as defined in claim 17 wherein each node involved in the IGBP messaging has knowledge of all optical network point-of-attachment and associated client level addresses.
